(19) United States
(12) Patent Application Publication
(10) Pub. No.: US 2026/0043970 A1
(43) Pub. Date: Feb. 12, 2026

(54) OPTICAL COMPONENT STRUCTURE AND OPTICAL TRANSCEIVER MODULE

(71) Applicant: ACCELIGHT TECHNOLOGIES (WUHAN) INC., Wuhan (CN)

(72) Inventors: GONG-EN GU, Wuhan (CN); MICHAEL XIAOYAN WEI, Wuhan (CN); William Sterling, Wuhan (CN); Meirong ZHANG, Wuhan (CN)

(73) Assignee: ACCELIGHT TECHNOLOGIES (WUHAN) INC., Wuhan (CN)

(21) Appl. No.: 19/361,956

(22) Filed: Oct. 17, 2025

(30) Foreign Application Priority Data
Dec. 19, 2024 (CN) 202411875114.0

(51) Int. Cl. G02B 6/38

(52) U.S. Cl. CPC G02B 6/3886; G02B 6/3845; G02B 6/3897

(57) ABSTRACT

An optical component structure includes a printed circuit board (PCB), the PCB is detachably connected to a grooved magnetic ring, a first mounting groove and a second mounting groove that communicate with each other are provided on the grooved magnetic ring, an isolator is disposed in the first mounting groove, and a fiber array fixture is fastened in the second mounting groove. Impact of a temperature change on a position of an optical component can be effectively reduced, a risk of isolator detachment is reduced, and overall stability and reliability of the optical transceiver module are improved.

### CROSS-REFERENCE TO RELATED APPLICATIONS

This application claims priority to Chinese Patent Application No. 202411875114.0 with a filing date of Dec. 19, 2024. The content of the aforementioned application, including any intervening amendments thereto, is incorporated herein by reference.

### TECHNICAL FIELD

The present disclosure relates to an optical component structure and an optical transceiver module, which belong to the field of optical transceiver module technologies.

### BACKGROUND

With the advent of the digital era, the Internet industry is experiencing booming growth, directly leading to a sustained increase in the demand for network communication devices. As a critical component of the network communication device, the optical transceiver module also undergoes innovation and development, to meet growing market demands. In addition, the rapid rise of new-generation information technologies such as cloud computing, artificial intelligence, and big data has significantly boosted the demand for computing power, thereby accelerating the construction of a cloud computing infrastructure. This trend leads to a surge in demand for high-speed optical transceiver modules such as 200G, 400G, 800G, and even 1.6T.

Currently, a primary method for manufacturing the optical transceiver module is to fasten a laser diode (LD) to a passive component by using structural adhesive. Specifically, a common method is to use adhesive to bond a single free-space isolator to a fiber array (FA). However, this method has some remarkable technical disadvantages. First, an optical component bonded with adhesive is prone to significant displacement when a temperature rises, directly affecting performance stability of the optical transceiver module. Then, a risk of isolator detachment is increased due to a plurality of bonding operations, leading to higher signal attenuation and ultimately compromising stability of the entire communication system.

In view of this, there is an urgent need in the industry to develop a new optical component structure to resolve the disadvantages in the existing technology.

### SUMMARY

Aiming at the defects in the prior art, An objective of the present disclosure is to provide an optical component structure and an optical transceiver module, to effectively reduce impact of a temperature change on a position of an optical component, reduce a risk of isolator detachment, and improve overall stability and reliability of the optical transceiver module. In addition, the present disclosure has the technical advantages of convenient component replacement, and reduced maintenance costs.

The technical solution adopted by the present disclosure to resolve the technical problem is as follows: The present disclosure provides an optical component structure, including a printed circuit board (PCB), a grooved magnetic ring detachably connected to the PCB, wherein the grooved magnetic ring comprises a first mounting groove and a second mounting groove communicated with each other; an isolator disposed in the first mounting groove; and a fiber array fixture fastened in the second mounting groove.

In one embodiment, an isolator locating seat is disposed in the first mounting groove, and an isolator is disposed on the isolator locating seat.

In one embodiment, a locating snap-fit is fixedly connected on the PCB, a pair of symmetrically arranged grippers are disposed on one end of the locating snap-fit, the locating snap-fit is connected to a pin holder block through the grippers, a grooved magnetic ring mounting hole that is configured to mount the grooved magnetic ring is provided on the pin holder block, and an end part of the pin holder block is connected to a pin in an axial limiting manner.

In one embodiment, a locating pin is disposed on the locating snap-fit, and a locating hole that is in one-to-one correspondence with the locating pin is provided on the PCB.

In one embodiment, a pin limiting plate is disposed between the gripper and the pin holder block, a pin limiting hole is provided on the pin limiting plate, and a width of the pin limiting hole is less than a diameter of the pin.

In a preferable implementation solution of the present disclosure, an axial locating annular groove that fits the pin limiting hole is provided on the pin, and the locating annular groove is in one-to-one correspondence with the pin limiting hole.

In one embodiment, a thickness of the pin limiting plate is not greater than a spacing between the gripper and the pin holder block.

In one embodiment, the isolator includes a first polarizing filter, a Faraday rotator, and a second polarizing filter, the first polarizing filter and the second polarizing filter are right-trapezoid-shaped, the Faraday rotator is cuboid, and the first polarizing filter and the second polarizing filter are bonded to two sides of the Faraday rotator in a 180° rotationally symmetric manner.

In one embodiment, the isolator includes a first polarizing filter, a Faraday rotator, and a second polarizing filter, a first glass spacer and a second glass spacer are disposed between the first polarizing filter and the second polarizing filter, the Faraday rotator is disposed between the first glass spacer and the second glass spacer, the first polarizing filter and the second polarizing filter are right-trapezoid-shaped, the first glass spacer, the second glass spacer, and the Faraday rotator are all cuboid, and the first polarizing filter and the second polarizing filter are bonded to two sides of the Faraday rotator in a 180° rotationally symmetric manner.

The present disclosure further provides an optical transceiver module, including the optical component structure described above.

The beneficial effects of the present disclosure are as follows: Through an innovative structural design, problems such as stability, reliability, and maintenance costs in the conventional technology are effectively resolved, to provide a more efficient, reliable, and cost-effective solution for the field of high-speed optical communication. Through this new structure, not only are stability and reliability of the optical transceiver module in various environmental conditions improved, but also a solid foundation is laid for the future development of the optical communication technology. Further, the optical component structure in the present disclosure may be a replaceable structure through which time for adhesive curing is reduced, a coupling process is simplified, and difficulty of a packaging process is reduced. Therefore, the raw material waste problem is effectively resolved, manufacturing and maintenance costs are reduced, and a production yield is increased. When an optical component in the optical transceiver module becomes faulty, only a passive optical component is replaced through the structure in the present disclosure. Since an angle of the polarizer is achieved through grinding, the angle of the polarizer can be flexibly adjusted according to different application requirements, and an angular tolerance can be greatly reduced by an order of magnitude of ten or more in the present disclosure. Further, the present disclosure overcomes a technical disadvantage in the conventional technology that the isolator is directly bonded to the module by using adhesive: When the isolator is damaged or defective, it cannot be reworked or disassembled, resulting in the entire product being discarded. According to the technical solution of the present disclosure, the technical problem can be effectively overcome, enabling quick and convenient component replacement and reducing maintenance costs.

First, through the detachably connected grooved magnetic ring design, the flexibility and maintainability of the optical component structure are remarkably improved in the present disclosure. The first and second mounting grooves on the grooved magnetic ring are respectively configured to mount the isolator and the fiber array fixture. Through this modular design, individual optical elements can be independently replaced or adjusted, significantly reducing maintenance cost and complexity. Moreover, since the isolator is no longer adhesively bonded to a front end of an optical channel of the fiber array (FA), problems such as increased optical attenuation due to a high temperature and a risk of adhesive failure causing isolator detachment are effectively resolved.

Then, an innovative locating and connection mechanism is introduced in the present disclosure. By providing the locating snap-fit and the locating hole on the PCB, along with the design of the pin holder block and the pin limiting plate, precise locating and a stable connection of various components in the optical path is achieved. Particularly, a dual-pin connection manner is adopted to improve assembly accuracy, and further significantly simplify a coupling process and improve production efficiency, thereby effectively reducing manufacturing costs. In this design, not only is position deviation caused by a temperature variation is reduced, but also performance stability of the optical transceiver module is significantly improved.

The optical component structure provided in the present disclosure has the following significant advantages and beneficial effects:

First, through the detachably connected grooved magnetic ring design, flexibility and maintainability of the optical component structure are remarkably improved in the present disclosure. The first and second mounting grooves on the grooved magnetic ring are respectively configured to mount the isolator and the fiber array fixture. Through this modular design, individual optical elements can be independently replaced or adjusted, thereby significantly reducing maintenance cost and complexity, and resolving the demagnetization problem of the free-space isolator during operation caused by a temperature change. Stable magnetic performance of the isolator can be kept in various temperature conditions through the structure of the grooved magnetic ring, thereby significantly improving long-term reliability of the optical transceiver module.

Then, an innovative locating and connection mechanism is introduced in the present disclosure. By providing the locating snap-fit and the locating hole on the PCB, along with the design of the pin holder block and the pin limiting plate, precise locating and a stable connection of various components in the optical component structure are achieved. Particularly, a dual-pin connection manner is adopted to improve assembly accuracy, and further significantly simplify the coupling process and improve production efficiency, thereby effectively reducing manufacturing costs. Through this design, not only is position deviation caused by a temperature variation is reduced, but also performance stability of the optical transceiver module is significantly improved.

Furthermore, through the ingenious design of the isolator locating seat, an adhesive-free connection at the front end of the optical channel of the FA is achieved in the present disclosure. Through this innovation, the problem of increased attenuation caused by a traditional adhesive fixing manner in a high-temperature environment is effectively resolved, and a risk of isolator detachment due to adhesive bonding failure is also eliminated. Through this adhesive-free connection manner, not only is stability of optical performance improved, but also a service life of the optical transceiver module is significantly prolonged. In addition, a foundation is laid for application of the present disclosure in a high-power scenario.

In addition, the structure of the isolator is optimized in the present disclosure. The right-trapezoid-shaped polarizer and the cuboid rotator/crystal are adopted in the present disclosure, not only improving transmission quality of optical signals, but also improving shock resistance of the overall structure.

Finally, innovative snap-fit structures are disposed on two sides of the locating snap-fit in the present disclosure, thereby facilitating convenient replacement in the event of failure of any optical component. This not only reduces the maintenance difficulty of the optical transceiver module, but also significantly reduces waste caused by scrapping of the entire module due to the failure of individual elements, thereby further reducing overall operational costs.

### BRIEF DESCRIPTION OF THE DRAWINGS

The present disclosure is described in further detail with reference to the accompanying drawings and embodiments. In the drawings:

FIG. 1 is a schematic diagram of an optical component structure according to the present disclosure;

FIG. 2 is a schematic diagram of a PCB and a locating snap-fit of an optical component structure according to the present disclosure;

FIG. 3 is a side view of a PCB and a locating snap-fit of an optical component structure according to the present disclosure;

FIG. 4 is a mounting schematic diagram of a locating snap-fit and a pin holder block of an optical component structure according to the present disclosure;

FIG. 5 is a schematic diagram of a pin of an optical component structure according to the present disclosure;

FIG. 6 is a mounting schematic diagram of a pin and a pin limiting plate of an optical component structure according to the present disclosure;

FIG. 7 is a sectional view along line A-A shown in FIG. 6;

FIG. 8 is a schematic diagram of a grooved magnetic ring according to the present disclosure;

FIG. 9 is a schematic diagram of a first isolator according to the present disclosure;

FIG. 10 is a top view of a first isolator according to the present disclosure;

FIG. 11 is a top view of a first isolator according to the present disclosure;

FIG. 12 is a schematic diagram of a second isolator according to the present disclosure; and

FIG. 13 is a schematic diagram of a second isolator according to the present disclosure.

### DETAILED DESCRIPTION OF THE EMBODIMENTS

In order to make the objectives, technical solutions, and advantages of the present disclosure clearer, the present disclosure is further described in detail below with reference to the accompanying drawings and examples. It should be understood that the specific embodiments described herein are intended merely to explain the present disclosure, rather than to limit the present disclosure.

### Embodiment 1

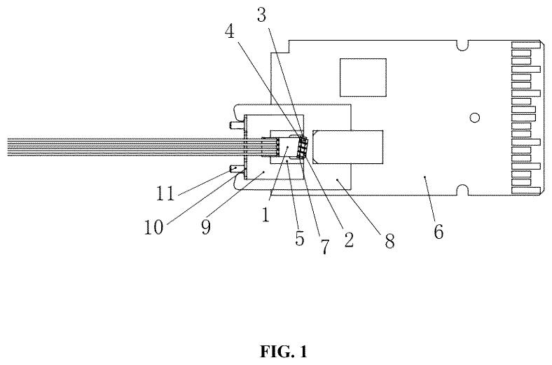

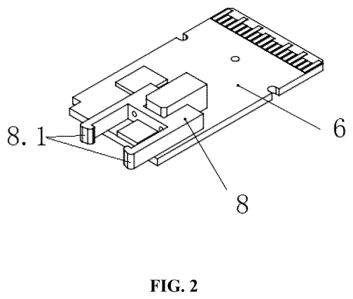

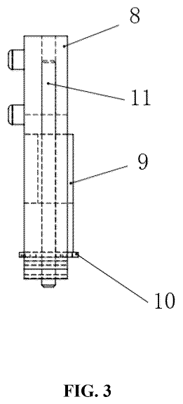

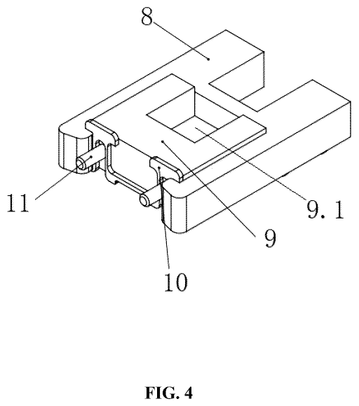

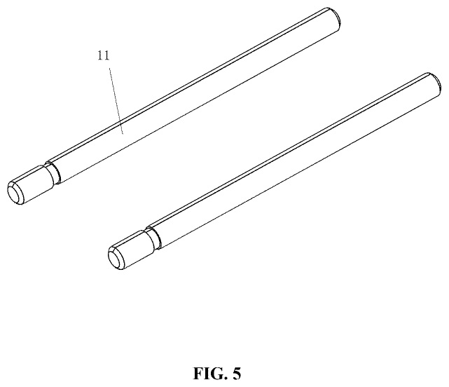

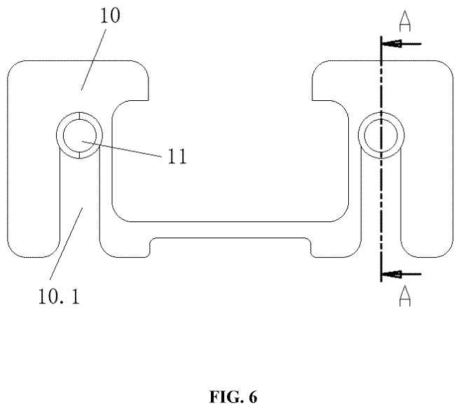

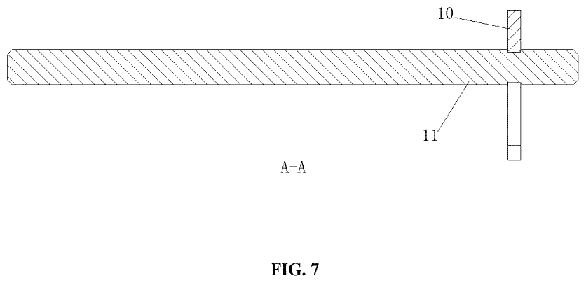

As shown in FIG. 1 to FIG. 7, this embodiment provides an optical component structure. The structure mainly includes components such as a PCB, a grooved magnetic ring, an isolator, a fiber array fixture, a locating snap-fit, a pin holder block, and a pin. The components are reliably connected and precisely located through a precise design.

First, the entire optical component structure is based on the PCB 6. The PCB 6 is a main carrier, and is configured to carry another component, and provide a necessary circuit connection. A detachably connected grooved magnetic ring 5 is designed on the PCB 6. Through this detachable design, flexibility of the device is improved, thereby facilitating later-stage maintenance and replacement.

The grooved magnetic ring 5 is one of core components of the device. Two mounting grooves that communicate with each other: a first mounting groove 5.1 and a second mounting groove 5.2 are provided on the grooved magnetic ring 5. The first mounting groove 5.1 is mainly configured to accommodate an isolator, and the second mounting groove 5.2 is configured to fasten a fiber array fixture 1. Through this design, an optical element is mounted and adjusted more conveniently.

An isolator locating seat 7 is disposed in the first mounting groove 5.1. The isolator locating seat 7 is mainly configured to: precisely locate and fasten the isolator. In this way, the isolator can be stably mounted on a predetermined position, to ensure normal working.

A locating snap-fit 8 is further fixedly connected on the PCB 6. A pair of symmetrically arranged grippers 8.1 are disposed on one end of the locating snap-fit 8. Through the design of the pair of grippers 8.1, stability of the device is improved, and a connection point is also provided for another component. The locating snap-fit 8 is connected to the pin holder block 9 through the grippers 8.1.

The pin holder block 9 is another important part. When the pin holder block 9 is configured to axially limit the pin, a center distance between two pins is precisely ensured. A grooved magnetic ring mounting hole 9.1 configured to mount the grooved magnetic ring 5 is provided on the pin holder block 9. This design ensures that the grooved magnetic ring 5 can be stably mounted on a predetermined position. In addition, an end part of the pin holder block 9 is further connected to a pin 11 through axial limiting. The pin 11 achieves critical electrical connection and locating effects in the entire device.

To further improve locating precision, a locating pin is disposed on the locating snap-fit 8, and a corresponding locating hole is provided on the PCB 6. This pin-hole fitted design ensures precise alignment between components.

A pin limiting plate 10 is disposed between the gripper 8.1 and the pin holder block 9. A pin limiting hole 10.1 is provided on the pin limiting plate 10, and a width of the pin limiting hole 10.1 is exquisitely designed to be smaller than a diameter of the pin 11. This design can effectively limit movement of the pin 11, and can improve stability of the overall device.

To achieve more precise locating, an axial locating annular groove is provided on the pin 11. The annular groove is in one-to-one correspondence with the pin limiting hole 10.1. Through this correspondence relationship, the pin 11 can be ensured to be precisely located in an axial direction.

It should be noted that a thickness design of the pin limiting plate 10 is also considered carefully. A thickness of the pin limiting plate 10 is not greater than a spacing between the gripper 8.1 and the pin holder block 9. This design ensures that the pin limiting plate 10 can be smoothly mounted, without affecting normal working of another component.

Through this design, components are precisely located and reliably connected via the optical component structure in this embodiment. This structure not only improves assembly precision, but also improves overall stability. In addition, the detachable design is also convenient for later-stage maintenance and replacement, thereby prolonging the service life of a product.

In addition, this device further resolves some problems in the conventional optical component structure. For example, replacing adhesive bonding with a mechanical connection effectively avoids a position displacement problem of the optical component in a high-temperature environment. In addition, the modular design allows for convenient replacement in the event of failure of any optical component, thus reducing maintenance costs.

The optical component structure provided in this embodiment achieves high precision, high stability, and ease of maintenance through the well-designed components and connection manners thereof, thereby providing new technical support for development of a high-speed optical transceiver module.

### Embodiment 2

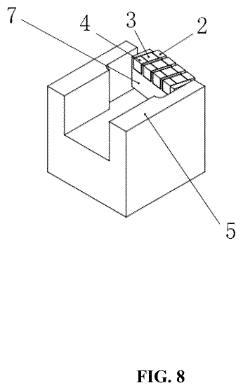

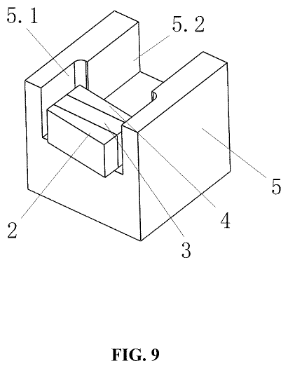

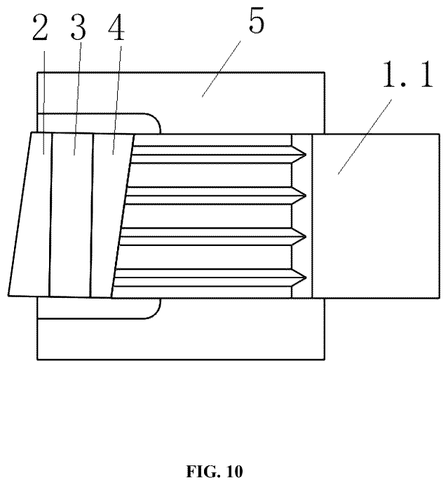

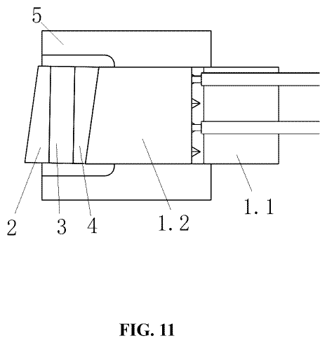

As shown in FIG. 8 to FIG. 11, an isolator in this embodiment mainly includes a grooved magnetic ring 5, a fiber array fixture 1, and an integrated isolator. This design is to improve stability, reliability, and performance of an optical transceiver module, and also simplifies the assembly process.

The grooved magnetic ring 5 is a core support part of the entire structure. Two critical mounting grooves: a first mounting groove 5.1 and a second mounting groove 5.2 are designed in the grooved magnetic ring 5. The first mounting groove 5.1 is configured to accommodate an isolator, and the second mounting groove 5.2 is configured to fasten a fiber array fixture 1. The two mounting grooves communicate with each other to establish a complete optical path system. It should be noted that the width of the first mounting groove 5.1 is greater than that of the second mounting groove 5.2. Different dimension requirements for the isolator and the fiber array fixture 1 are considered in this design, ensuring that components can be precisely located and fastened.

The integrated isolator includes a minimum of three components: a first polarizing filter 2, a Faraday rotator 3, and a second polarizing filter 4. Stability and reliability of the isolator is greatly improved through an integrated design of the three components. Specifically, both the first polarizing filter 2 and the second polarizing filter 4 are right-trapezoid-shaped, and the Faraday rotator 3 is cuboid. The three components are the same in width, ensuring consistency and stability of an optical path.

In terms of assembly, the first polarizing filter 2 and the second polarizing filter 4 are disposed relative to the Faraday rotator 3 in a 180° rotationally symmetric manner. Through this symmetrical design, not only is the optical path optimized, but also transmission quality of an optical signal is improved. The first polarizing filter 2 and the second polarizing filter 4 are respectively bonded to two sides of the Faraday rotator 3 to form a stable integer. Two rectangular planes of the Faraday rotator 3 and rectangular planes of the first polarizing filter 2 and the second polarizing filter 4 correspond to each other in shape. Stability and optical performance of the component are further improved through this precise geometric matching.

A mounting requirement for the isolator is further considered in designing the grooved magnetic ring 5. The width of the first mounting groove 5.1 is greater than the width of the first polarizing filter 2. Enough space is provided in this design for mounting and adjusting the isolator, thereby facilitating precise locating and fastening.

The fiber array fixture 1 is an important component connecting the fiber array to the isolator. The fiber array fixture 1 is mounted in the second mounting groove 5.2 of the grooved magnetic ring 5, ensuring precise alignment between the fiber array and the isolator.

Several important technical considerations are reflected in the design of this optical component structure. First, through the integrated design of the isolator, relative displacement that may occur in a traditional multi-component isolator is reduced, thereby enhancing overall stability. Then, not only is stable support provided by the design of the grooved magnetic ring 5, but also precise positioning of each component is achieved through proper groove layout. Then, the width of the first mounting groove 5.1 is greater than the width of the isolator, thereby providing convenience in mounting and adjusting the isolator, and helping improve assembly efficiency and precision.

In conclusion, this optical component structure, through innovative design and precise geometric configuration, has effectively resolved problems such as stability, reliability, and assembly difficulty in the traditional optical transceiver module. This not only simplifies a production process, but also improves product performance, thereby providing an optimized resolution in the high-speed optical communication field.

Specifically, both the first polarizing filter 2 and the second polarizing filter 4 are right-trapezoid-shaped, and the Faraday rotator 3 is cuboid, thereby forming a combination that is perfectly matched geometrically. Through this device, not only is accuracy of an optical path ensured, but also stability of the overall device is improved. The widths of the first polarizing filter 2, the Faraday rotator 3, and the second polarizing filter 4 are designed to be the same, thereby further ensuring consistency and stability of the optical signal in a transmission process.

Through a communication design between the first mounting groove 5.1 and the second mounting groove 5.2 inside the grooved magnetic ring 5, a continuous and stable channel is provided for transmission of the optical signal. The width of the first mounting groove 5.1 is greater than that of the second mounting groove 5.2, thereby meeting different dimension requirements for the isolator and the fiber array fixture 1, and providing greater operation space for mounting and adjusting the isolator.

This optical component structure is required to play an important role in actual application, thereby promoting further development of the optical communication technology. In this way, a stable and efficient basic component is provided for a high-speed and high-reliability optical communication system, helping meet an increasingly growing data transmission need.

### Embodiment 3

Based on Embodiment 2, an optical component structure is further optimized in design of an isolator locating seat in this embodiment. This improvement is to improve locating precision and stability of an isolator, thereby further improving overall performance of an optical transceiver module.

Specifically, a special isolator locating seat is disposed in a first mounting groove 5.1 of a grooved magnetic ring 5. A design and a material of the locating seat are carefully considered. The locating seat may be processed by using a glass or ceramic material. Both the glass material and the ceramic material have excellent thermal stability and mechanical strength, thereby keeping shape stability in various working conditions, and ensuring precise locating of the isolator.

Four grooves are processed on an upper surface of the isolator locating seat. This is a key creative point of this embodiment. The four grooves are not randomly designed, but are provided through precise computing and locating Through this structural design, a center distance of the isolator can be precisely controlled, to ensure that relative positions of a plurality of isolators are kept stable in a horizontal direction. In addition, through this design, an included angle between the isolator and transmission light can be further precisely controlled, and therefore, it is critical to ensure transmission quality of an optical signal.

During actual application, the integrated isolator (mainly including a first polarizing filter 2, a Faraday rotator 3, and a second polarizing filter 4) can be stably mounted on the locating seat. The four grooves are designed to provide a clear mounting position for the isolator, thereby greatly reducing a manual operation error, and improving assembly precision and consistency.

Through this improved design, a problem of imprecise isolator location within a traditional optical transceiver module is resolved. The position and an angle of the isolator can be kept stable under a temperature change or external vibration. This is critical for maintaining the long-term reliability of the optical transceiver module.

In addition, maintenance and replacement processes are further simplified through the isolator locating seat. During isolator replacement, only an old isolator is required to be taken down from the locating seat, and then a replacement isolator is mounted in a preset groove, and therefore, a complex adjustment process is not required.

The position and the angle of the isolator are precisely controlled through the improved design in this embodiment, thereby further improving performance and reliability of the optical component structure. This not only improves transmission quality of an optical signal, but also improves stability of the entire optical transceiver module in various working conditions, thereby providing more reliable technical support for development of a high-speed optical communication system.

### Embodiment 4

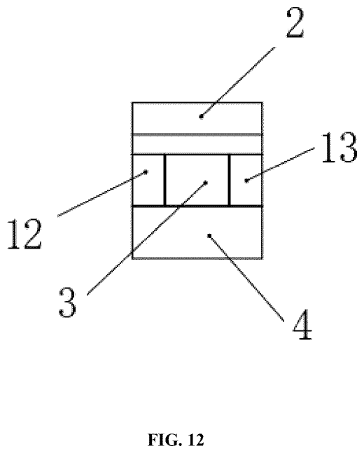

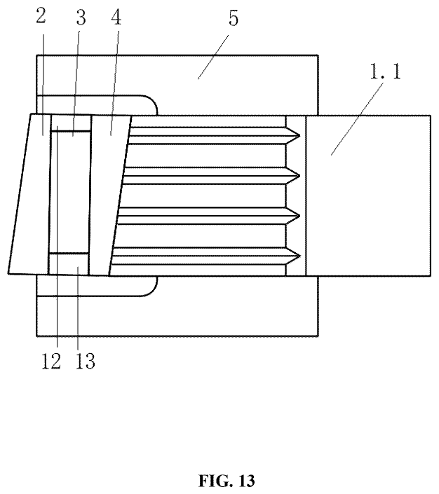

As shown in FIG. 12 and FIG. 13, this embodiment provides another isolator structure. A first polarizing filter 2 and a second polarizing filter 4 are spaced apart on the isolator structure in an X-axis direction, and are respectively located on two ends of the isolator structure. Therefore, a starting point and an ending point of optical signal processing are formed in terms of function. Two glass spacers are spaced apart between the first polarizing filter 2 and the second polarizing filter 4 in a Z-axis direction. A first glass spacer 12 is close to the polarizer, and a second glass spacer 13 is close to an analyzer. A Faraday rotator 3, as a structural core, is precisely placed between the two glass spacers, and is located on a center position of the entire structure. The Faraday rotator 3 may be made of garnet crystal.

The first polarizing filter 2 and the second polarizing filter 4 are both in a right-angled trapezoid design. This shape is conductive to optical signal processing, and is further convenient for assembling and fastening of the entire structure. It should be further noted that the first polarizing filter 2 and the second polarizing filter 4 are disposed relative to a Y-axis in a 180° rotationally symmetric manner. Through this symmetrical design, not only is stability of the device improved, but also consistency and reliability of optical signal processing are improved. Although functionally distinct, the first polarizing filter 2 and the second polarizing filter 4 have a completely same shape. This design simplifies a manufacturing process and helps reduce production costs.

In terms of material selection and shape design, the first glass spacer 12, the second glass spacer 13, and the Faraday rotator 3 all feature a cuboid shape. This regular geometric shape facilitates precise processing and assembly, thereby ensuring stability and reliability of the entire device. It should be particularly noted that a thickness of the first glass spacer 12 is optimized and designed to be twice that of the second glass spacer 13. This asymmetrical thickness design is based on optical principles and practical application requirements, and is designed to optimize transmission and processing of an optical signal.

Upon entering the isolator structure, the optical signal first passes through the first polarizing filter 2, so as to be adjusted to a specific polarization state. Then, the optical signal sequentially passes through the first glass spacer 12, the Faraday rotator 3, and the second glass spacer 13. In the entire process, the Faraday rotator 3 plays a key role, and is configured to change a polarization direction of the optical signal through Faraday effect. Finally, the optical signal reaches the second polarizing filter 4, to complete final signal processing. In the entire process, components are precisely arranged and specially designed to ensure that the optical signal is transmitted in a best state. In addition, any possibly reverse signal interference is effectively blocked. In a preferable implementation solution of the present disclosure, the isolator includes a first polarizing filter 2, a Faraday rotator 3, and a second polarizing filter 4. The first polarizing filter 2 and the second polarizing filter 4 are right-trapezoid-shaped, the Faraday rotator 3 is cuboid, and the first polarizing filter 2 and the second polarizing filter 4 are bonded to two sides of the Faraday rotator 3 in a 180° rotationally symmetric manner.

In a preferable implementation solution of the present disclosure, the isolator includes a first polarizing filter 2, a Faraday rotator 3, and a second polarizing filter 4. A first glass spacer 12 and a second glass spacer 13 are disposed between the first polarizing filter 2 and the second polarizing filter 4. The Faraday rotator 3 is disposed between the first glass spacer 12 and the second glass spacer 13, and the first polarizing filter 2 and the second polarizing filter 4 are right-trapezoid-shaped. The first glass spacer 12, the second glass spacer 13, and the Faraday rotator 3 are all cuboid. The first polarizing filter 2 and the second polarizing filter 4 are bonded to two sides of the Faraday rotator 3 in a 180° rotationally symmetric manner.

### Embodiment 5

This embodiment describes manufacturing steps of the optical component structure in detail, and shows complete progression from individual optical component to a complete optical transceiver module. This manufacturing process embodies characteristics of precision optical manufacturing by addressing a critical role of each step and its impact on performance of a final product.

In step 1, an integrated isolator is assembled.

First, a first polarizing filter 2 and a second polarizing filter 4 are respectively bonded to two sides of a Faraday rotator 3, to form an integrated structure. Highly precise alignment and a stable bonding process are required in this step, to ensure perfect integration between the three components. In a bonding process, a thickness of an adhesive layer is required to be uniform, and stress is avoided, thereby ensuring optical performance.

In step 2, the isolator is diced.

A large isolator is diced through a precision dicing machine. The dicing machine is required to have high precision and good stability in this step, to ensure each diced isolator part to be consistent in size, and flat and crack-free on an edge. A dicing speed and cooling are required to be controlled in the dicing process, to avoid impact of thermal stress on performance of the isolator.

In step 3, the isolator is ground.

Both ends of the diced isolator part are precision-ground and polished to a specified angle, so as to form an integrated free-space isolator. Optical performance of the isolator is directly affected in this step, and a high-precision grinding device and process are required. An angle and surface quality are required to be strictly controlled in a grinding process, to ensure that a light-incident angle and a light-emergent angle meet design requirements.

In step 4, a fiber array is assembled.

First, front ends of optical fibers are processed, and then a V-groove base plate is fastened via a special assembly fixture. Then, the processed optical fibers are sequentially put in, and a glass cover plate is placed over the optical fibers, to ensure that a front end of the V-groove base plate is flush to a front end of the glass cover plate. Finally, UV optical adhesive is dispensed and cured, to firmly bond the three components (i.e. the processed optical fiber, V-groove base plate, and glass cover plate) together. High precision and high stability are required in this step, to ensure that the optical fiber is precisely located and fastened in a V-groove.

In step 5, an end face of the fiber array is processed.

Optical fibers at a front end of the assembled fiber array (FA) are ground and polished. Transmission quality of an optical signal is directly affected in this step, and a precision grinding and polishing device is required to control polishing pressure, speed and time, to obtain ideal end face quality.

In step 6, final assembly and debugging are performed.

First, an ultraviolet (UV) adhesive is dispensed into a rear end of the groove magnetic ring 5. Then, the FA is inserted into the rear end of the grooved magnetic ring 5, and the integrated isolator is put into the front end of the grooved magnetic ring 5. Precise debugging is performed under a coupling machine until all parameters meet required criteria. Finally, the adhesive is cured to fasten all optical components to correct positions. A high-precision coupling device and proficient operational skills are required in this step, to ensure that optical performance of a final product meet design requirements.

It should be understood that the serial number of each step in the above embodiment does not indicate the order of performing the step. The order of performing each process is determined by its function and internal logic, and should not limit the implementation of the embodiments of the present disclosure.

It should be understood that those of ordinary skill in the art can make improvements or transformations based on the above description, and all these improvements and transformations should fall within the protection scope of the appended claims of the present disclosure.

What is claimed is:

1. An optical component structure, comprising:
a printed circuit board (PCB) (6),
a grooved magnetic ring (5) detachably connected to the PCB (6), wherein the grooved magnetic ring (5) comprises a first mounting groove (5.1) and a second mounting groove (5.2) communicated with each other;
an isolator disposed in the first mounting groove (5.1);
a fiber array fixture (1) fastened in the second mounting groove (5.2);
a locating snap-fit (8) fixedly connected on the PCB (6), wherein a pair of symmetrically arranged grippers (8.1) are disposed on one end of the locating snap-fit (8);
a pin holder block (9) connected to the locating snap-fit (8) through the grippers (8.1), wherein a grooved magnetic ring mounting hole (9.1) that is configured to mount the grooved magnetic ring (5) is provided on the pin holder block (9); and
a pin (11) connected to an end part of the pin holder block (9) in an axial limiting manner.

2. The optical component structure according to claim 1, wherein an isolator locating seat (7) is disposed in the first mounting groove (5.1), and an isolator is disposed on the isolator locating seat (7).

3. The optical component structure according to claim 1, wherein a locating pin is disposed on the locating snap-fit (8), and a locating hole that is in one-to-one correspondence with the locating pin is provided on the PCB (6).

4. The optical component structure according to claim 1, wherein a pin limiting plate (10) is disposed between the gripper (8.1) and the pin holder block (9), a pin limiting hole (10.1) is provided on the pin limiting plate (10), and a width of the pin limiting hole (10.1) is less than a diameter of the pin (11).

5. The optical component structure according to claim 4, wherein an axial locating annular groove that fits the pin limiting hole (10.1) is provided on the pin (11), and the locating annular groove is in one-to-one correspondence with the pin limiting hole (10.1).

6. The optical component structure according to claim 4, wherein a thickness of the pin limiting plate (10) is not greater than a spacing between the gripper (8.1) and the pin holder block (9).

7. The optical component structure according to claim 1, wherein the isolator comprises a first polarizing filter (2), a Faraday rotator (3), and a second polarizing filter (4), the first polarizing filter (2) and the second polarizing filter (4) are right-trapezoid-shaped, the Faraday rotator (3) is cuboid, and the first polarizing filter (2) and the second polarizing filter (4) are bonded to two sides of the Faraday rotator (3) in a 180° rotationally symmetric manner.

8. The optical component structure according to claim 1, wherein the isolator comprises a first polarizing filter (2), a Faraday rotator (3), and a second polarizing filter (4), a first glass spacer (12) and a second glass spacer (13) are disposed between the first polarizing filter (2) and the second polarizing filter (4), the Faraday rotator (3) is disposed between the first glass spacer (12) and the second glass spacer (13), the first polarizing filter (2) and the second polarizing filter (4) are right-trapezoid-shaped, the first glass spacer (12), the second glass spacer (13), and the Faraday rotator (3) are all cuboid, and the first polarizing filter (2) and the second polarizing filter (4) are bonded to two sides of the Faraday rotator (3) in a 180° rotationally symmetric manner.

9. An optical transceiver module, comprising the optical component structure according to claim 1.

10. An optical transceiver module, comprising the optical component structure according to claim 2.

11. An optical transceiver module, comprising the optical component structure according to claim 3.

12. An optical transceiver module, comprising the optical component structure according to claim 4.

13. An optical transceiver module, comprising the optical component structure according to claim 5.

14. An optical transceiver module, comprising the optical component structure according to claim 6.

15. An optical transceiver module, comprising the optical component structure according to claim 7.

16. An optical transceiver module, comprising the optical component structure according to claim 8.
